(19) United States
(12) Patent Application Publication
(10) Pub. No.: US 2026/0264297 A1
(43) Pub. Date: Sep. 10, 2026

(54) A METHOD OF MANUFACTURING A POLYURETHANE (PU)- EXPANDED POLYSTYRENE (EPS) HYBRID MATERIAL SURFBOARD

(71) Applicant: Dylan JOHNSON, Suffolk Park, New South Wales (AU)

(72) Inventor: Dylan JOHNSON, Suffolk Park, New South Wales (AU)

(21) Appl. No.: 19/168,933

(22) PCT Filed: Apr. 10, 2024
(86) PCT No.: PCT/AU2024/050340

§ 371 Date: Sep. 25, 2025

(30) Foreign Application Priority Data
Apr. 12, 2023 (AU) 2023901063

(51) Int. Cl. B29C 45/00; B29C 45/14; B29K 25/00; B29K 75/00; B29L 31/52

(52) U.S. Cl. CPC B29C 45/0001; B29C 45/0055; B29C 45/14008; B29C 2045/0079; B29K 2025/06; B29K 2075/00; B29L 2031/5272

(57) ABSTRACT

A method of manufacturing a polyurethane-expanded polystyrene hybrid material surfboard, the method comprising: (i) inserting a sheet of expanded polystyrene comprising a plurality of positioning lugs into an interior of a mould cavity formed from at least one mould; (ii) clamping the mould such that the sheet of expanded polystyrene is enclosed; (iii) injecting polyurethane into the mould cavity such that the void between the expanded polystyrene and mould cavity is filled with the polyurethane; (iv) setting and removing the surfboard from the mould; (v) subjecting the surfboard blank to further processing to fine tune the surfboard profile and shape; and (vi) glassing the shaped board using bio-based epoxy resin along with advanced recycled cloth fibres and finally subjecting to sanding process to obtain the final surfboard.

### TECHNICAL FIELD

The present invention relates to surfboards and more particularly to a novel method of manufacturing a surfboard. Furthermore, the invention relates to the manufacturing of a surfboard comprised of a polyurethane (PU)-expanded polystyrene (EPS) hybrid material prepared by a novel method.

### BACKGROUND

Surfing is a popular water sports worldwide. The surfboards used by the surfers first originated in Polynesia and early surfboards were made of wood from local trees. Surfboards are supposed to be light but at the same time strong enough to support an individual surfing on it. Over the years, a lot of advancement has taken place in terms of the shape and the materials used to make surfboards.

Modern surfboards are made of either polyurethane or polystyrene foam covered with layers of fiberglass cloth, and polyester or epoxy resin. In general process of manufacturing the surfboard, a polyurethane foam blank is individually hand-shaped to form a surfboard onto which are applied fiberglass and resin. U.S. Pat. No. 4,713,032 to TAA Technique and Administration AG, discloses a method of manufacture of a surfboard wherein a prefabricated foam core, having fibrous material wound about it, is taken and a polyurethane resin set with a reaction retarder is poured onto the fibrous material, whereupon the treated foam core is inserted into a moulding tool and the mould is closed for curing the polyurethane resin. It provides low-weight boards of high strength with relatively low production and material costs.

In recent years, materials other than polyurethane have been used in producing surfboards. U.S. Pat. No. 6,779,478 to Esposito describes a “surfboard made of high-density ethyl vinyl acetate wrapped in a polyethylene shell.” The surfboard is formed by cutting the ethyl vinyl acetate in the shape of a surfboard followed by wrapping it in a protective polyethylene shell, and heating the polyethylene-wrapped shape to fuse the polyethylene with the ethyl vinyl acetate.

U.S. Pat. No. 7,846,000 to Cox discloses a surfboard comprising a foam blank which is made using carbon fiber materials on the blank, and a fiberglass laminate enveloping the rails and blank. Further, it is disclosed that the use of carbon fiber material offers strength at a substantially reduced mass.

It is known that the polyurethane boards are more dense. The high density of polyurethane boards helps the board to sit in the water more but at the same time makes the surfboard heavier. However, this is disadvantageous to professional surfers/those who want to get air or more manoeuvrability. Expanded Polystyrene boards, on the other hand, are light and ‘bumpy’, and whilst allow more air time, are tough to ride in conditions where the wave surface is not as flat. Therefore, there is a need in the art for a surfboard with better buoyancy and manoeuvrability at the same time and hence, there also exists a need for an improved method for manufacturing such efficient surfboards with improved properties.

Polyurethane and expanded polystyrene (EPS) are two of the most commonly used materials for the core of surfboards. Polyurethane foam is denser than EPS foam, which means that polyurethane boards are typically heavier and more durable. EPS boards are lighter, which can make them easier to manoeuvre in the water, but they are also more prone to damage. Polyurethane foam is more flexible than EPS foam, which can make it easier to control the board and make turns. EPS foam is stiffer, which can make the board feel more stable and fast, but it can also make it more difficult to control. Polyurethane foam is typically more expensive than EPS foam, which can make polyurethane boards more expensive overall. EPS foam is cheaper, which can make EPS boards a more affordable option for surfers on a budget. EPS foam is considered to be more environmentally friendly than polyurethane foam because it can be recycled more easily. EPS foam can also be molded into a shape with less waste material, which makes it a more sustainable option overall.

Any discussion of the prior art throughout the specification should in no way be considered as an admission that such prior art is widely known or forms part of common general knowledge in the field.

### SUMMARY

### Problems to be Solved

It may be an objective of the present invention to provide a method for the manufacture of a polyurethane-expanded polystyrene (EPS) hybrid board, where the advantages of each material are combined in one board to afford a new type of board which inherits the benefits of both a typical polystyrene board and an expanded polystyrene board.

It may be an objective of the present invention to provide a method for the manufacture of a polyurethane-EPS board such that it can become commercially available at a low cost.

It may be an objective of the present invention to provide a method for the manufacture of a board having some or all of the following properties: medium buoyancy such that the board sits in the water whilst also being capable of achieving high manoverability and ‘air-time’, light weight whilst still being sturdy in the water.

It may be an objective of the present invention to provide a method for the manufacture of a board that utilises EPS inserts which otherwise would have ended up in landfill, therefore making it environmentally sustainable and friendly.

It may be an objective of the present invention to provide a method for the manufacture of a board which is analogous and equivalent to a surfboard for purposes of this specification.

It may be an objective of the present invention to provide a method for the manufacture of a board which contains and EPS insert derived from at least on of the following sources: building cladding, road construction waste, fridge waste, insulated batting, dispose ski and motorbike helmets, packaging waste.

As discussed above, the surfboards made of only polyurethane are heavier which causes issues with trying to get more air-time during competitions. Whereas, the surfboards made from only expanded polystyrene are lighter in weight but are not able to provide a good surfing experience where the water is not that flat or where the waves are bigger. Hence there is a need in the art for an improved surfboard with better buoyancy and manoeuvrability and therefore, a need for an improved method of manufacture of surfboards that have the desired properties of a surfboard.

It is an object of the present invention to overcome or ameliorate at least one of the disadvantages of the prior art, or to provide a useful alternative.

### Means for Solving the Problem

In a first aspect of the present invention, there is provided a method of manufacturing a polyurethane-expanded polystyrene hybrid material surfboard, the method comprising inserting a sheet of expanded polystyrene comprising a plurality of positioning lugs into an interior of a mould cavity formed from at least one mould, clamping the mould such that the sheet of expanded polystyrene is enclosed, injecting the polyurethane into the mould cavity such that the void between the expanded polystyrene and mould cavity is filled with the polyurethane, setting and remove the surfboard from the mould, subjecting the surfboard blank to further processing to fine tune the surfboard profile and shape and glassing the shaped board using bio-based epoxy resin with advanced recycled cloth fibres and finally subjecting to a sanding process to obtain the final surfboard.

Preferably, the expanded polystyrene (EPS) sheet is manufactured using a pre-designed mould.

Preferably, the polyurethane blank moulds are of pre-designed shapes to customize the finished product dimensions.

Preferably, the moulds for manufacturing expanded polystyrene sheet and the mould in which the expanded polystyrene sheet is inserted for injecting polyurethane are made to have a plurality of positioning lugs.

Preferably, the polyurethane mixture for injecting into the mould is prepared by weighing each ingredient of the polyurethane mixture i.e. ISO-POLY in a predetermined ratio and mixed on purpose built mixers to get the exact consistency of the Polyurethane foam.

Preferably, the step of setting and removing the finished surfboard from the mould comprises the steps of covering the blank in the mould comprising polyurethane (PU) and expanded polystyrene (EPS) foam with specialised paper, closing the mould using locking hydraulic mechanism, leaving it for 10-120 minutes for the PU foam to react with itself at the pre-set temperature, taking out the blank made of the hybrid material of EPS and PU and allowed it to cool for 1 hour.

Preferably, the further processing of the surfboard comprises the steps of removing the paper from the blank made of the hybrid material of EPS and PU, steaming and curing the blank wherein the process comprises of wetting the surface of the PU foam from top to bottom and placing into a steam room, removing the blank from the steaming room and allowing it to dry, gluing the stringers to the blank wherein the stringers may be made of wood, or a variety of composite stringer materials; and, profiling and shaping the surfboard in a CNC shaping machine and sanding to obtain a shaped surfboard.

Preferably, the surfboard is comprising of a polyurethane (PU)-expanded polystyrene (EPS) hybrid material and has a nose 201, a tail 202, a top surface 203, a bottom surface 204, a deck 205 and a stringer 208 wherein the bottom surface of the surfboard comprises the lugs 205 for installing the fins are present at the tail area 202.

Preferably, the surfboard has increased strength, manoeuvrability and sufficient buoyancy.

In the context of the present invention, the words “comprise”, “comprising” and the like are to be construed in their inclusive, as opposed to their exclusive, sense, that is in the sense of “including, but not limited to”.

The invention is to be interpreted with reference to the at least one of the technical problems described or affiliated with the background art. The present invention aims to solve or ameliorate at least one of the technical problems and this may result in one or more advantageous effects as defined by this specification and described in detail with reference to the preferred embodiments of the present invention.

### BRIEF DESCRIPTION OF THE FIGURES

FIG. 1 depicts a front view of the expanded polystyrene (EPS) insert or sheet in accordance with an embodiment of the present invention.

FIG. 2 depicts the rear view of the expanded polystyrene (EPS) insert or sheet in accordance with an embodiment of the present invention.

FIG. 3 illustrates a front view of the surfboard in accordance with an embodiment of the invention.

FIG. 4 illustrates a rear view of the surfboard in accordance with an embodiment of the invention.

### DESCRIPTION OF THE INVENTION

Preferred embodiments of the invention will now be described with reference to the accompanying drawings and non-limiting examples.

A first aspect of the present invention may relate to a method of manufacturing a surfboard wherein the surfboard is made from a polyurethane-expanded polystyrene hybrid material.

In an embodiment of the invention the expanded polystyrene (EPS) sheet is first designed as per the desired shape and in the desired density. The density of the inner core material utilised while manufacturing surfboards is of importance as by increasing the density of the core material the finished surfboard can be strengthened without affecting its flexibility. The EPS moulds for designing the EPS sheet are first manufactured in the chosen shape to produce the EPS insert. Further, it is also desirable that the Polyurethane blank moulds are also moulded in the desired shapes to be able to customize the finished product dimensions.

In an embodiment of the invention the EPS moulds and the PU moulds are made to have a plurality of positioning lugs. The provision of a plurality of positioning lugs in the moulds helps in the insertion of the fins in the surfboards.

According to an embodiment of the invention, in the method of manufacturing a polyurethane-expanded polystyrene hybrid material surfboard, the step of setting and removing the finished surfboard from the mould comprises of:
covering the blank in the mould comprising polyurethane (PU) and expanded polystyrene (EPS) foam with a specialised paper;
closing the mould using locking hydraulic mechanism;
leaving it for 10-120 minutes for the PU foam to react with itself at the pre-set temperature;
taking out the blank made of the hybrid material of EPS and PU and allowing it to cool.

According to a further embodiment of the invention, in the method of manufacturing a polyurethane-expanded polystyrene hybrid material surfboard, the further processing of the surfboard comprises of:
removing the paper from the blank made of the hybrid material of EPS and PU;
steaming and curing the blank wherein the process comprises of wetting the surface of the PU foam from top to bottom and placing into a steam room;
removing the blank from the steaming room and allowing it to dry;
gluing the stringers to the blank wherein the stringers may be made of wood, or a variety of composite stringer materials; and
profiling and shaping the surfboard in a CNC shaping machine and sanding to obtain a shaped surfboard.

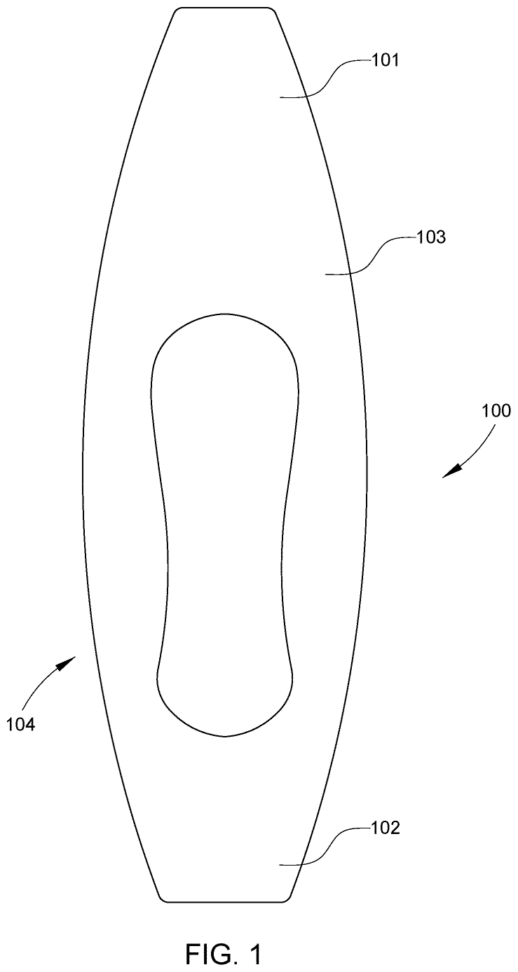

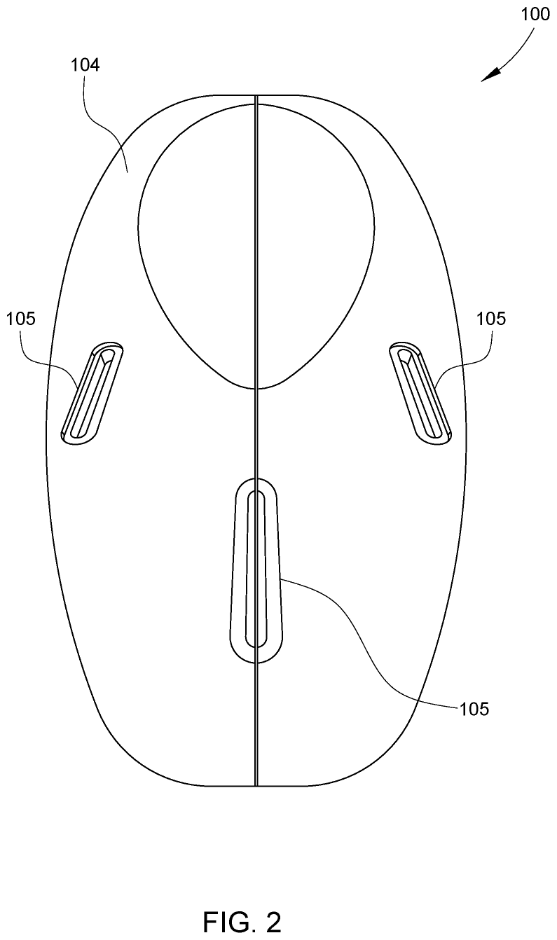

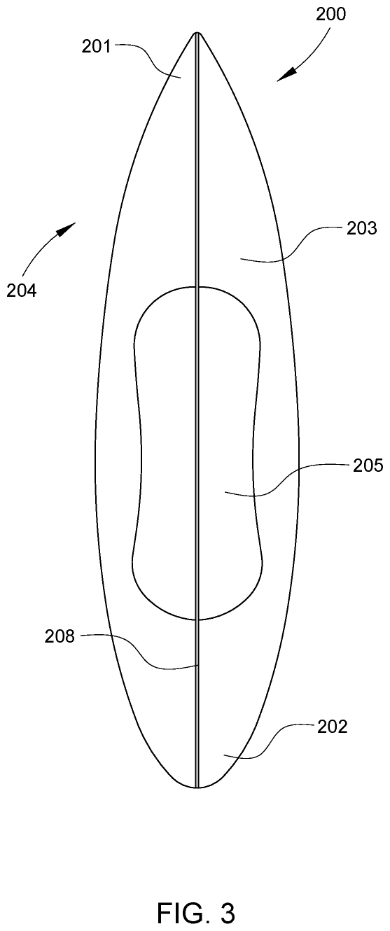

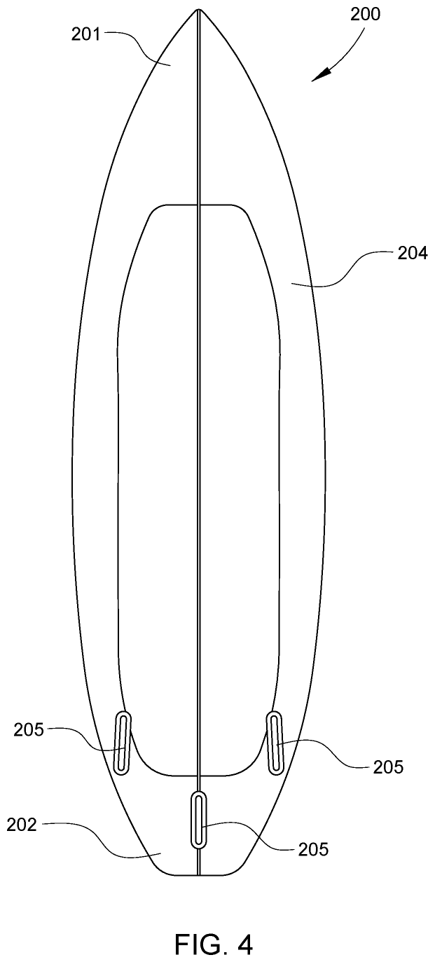

The method of manufacturing a polyurethane-expanded polystyrene hybrid material surfboard comprises taking the sheet of expanded polystyrene comprising a plurality of positioning lugs. The FIG. 1 is illustrating the expanded polystyrene (EPS) sheet 100, the sheet is having a nose 101 and a tail 102. The EPS sheet or insert has a top surface 103 and a bottom surface 104. The FIG. 2 illustrates the bottom surface 104 of the EPS sheet having the pre-set lugs 105 for installing the fins in the final product i.e., surfboard. This EPS sheet or insert 100 is inserted it into an interior of a mould cavity formed from at least one mould (Polyurethane mould) and the mould is clamped such that the sheet of expanded polystyrene 100 is enclosed. Further, a polyurethane mixture is poured into the mould cavity such that the void between the expanded polystyrene and mould cavity is filled with the polyurethane. The polyurethane foam is poured along the sides and around the edges of the EPS insert. The polyurethane mixture which is to be used is prepared by weighing each ingredient of the polyurethane mixture i.e., ISO-POLY in a predetermined ratio and mixed on purpose-built mixers to get the exact consistency of the Polyurethane foam. The blank in the mould comprising polyurethane (PU) and expanded polystyrene (EPS) foam is then covered with a specialised paper and the mould is closed using locking hydraulic mechanism and left for 10-120 minutes for the PU foam to react with itself at the pre-set temperature. The heat creates a fusion bond between the EPS and PU foams moulding them as one. After 10-120 minutes, the blank made of the hybrid material of EPS and PU is taken out and allowed to cool for 1 hour. This is followed by removing the paper and making the blank ready for steaming and curing process. The surface of the PU foam is wetted from top to bottom and placed into a custom built steam room. As the blank is removed from the steaming room, it is allowed to dry for 1 hour. At this stage the Polyurethane (PU) foam has completely cured and fused with the expanded polystyrene (EPS) foam giving the final blank for the desired surfboard. In the final stages, the stringers are glued to the blank wherein the stringers may be made of wood, or a variety of composite stringer materials. Finally, the blank is placed onto a custom built CNC shaping machine for profiling and the surfboard profile is fine-tuned and shaped. This shaped board is glassed using bio-based epoxy resin along with advance recycled cloth fibres. The board is thus finally subjected to sanding process to obtain the final finished product i.e., the surfboard. FIG. 3 is depicting the final product i.e. the surfboard 200 having a nose 201, a tail 202, a top surface 203, a bottom surface 204, a deck 205 and a stringer 208. FIG. 4 is showing the bottom surface 204 of the finished product i.e. the surfboard, wherein the lugs 205 for installing the fins are present at the tail area 202.

In the aforementioned embodiment, Iso-poly is a type of polyurethane foam that is used in the manufacturing of surfboard blanks. It is a hybrid material that combines the properties of both polyurethane and polystyrene foam, which are the two most common types of foam used in surfboard production.

Iso-poly foam is known for its durability, buoyancy, and weight-saving properties. It is a closed-cell foam, which means that it is resistant to water absorption and is less likely to rot or degrade over time. It is also more resilient and less likely to dent or compress than traditional polyurethane foam, which can help extend the life of the surfboard.

The name “iso-poly” comes from the fact that the foam is made using a combination of isocyanate and polyol chemicals, which are mixed together to create a chemical reaction that produces the foam. The foam can be produced in a variety of densities and stiffness levels, depending on the needs of the surfboard manufacturer and the desired characteristics of the final product. Iso-poly foam has become a popular choice for surfboard manufacturers who want to create high-performance, durable surfboards that can withstand the rigors of regular use. While it is more expensive than traditional polyurethane foam, its superior performance and longevity can make it a worthwhile investment for serious surfers.

The shaping step may be performed using a CNC shaping machine. A CNC shaping machine is a computer-controlled machine used to shape surfboard blanks. CNC stands for “Computer Numerical Control,” which means that the machine is controlled by a computer program that uses numerical codes to direct the movements of the cutting tools. CNC shaping machines have revolutionized the surfboard manufacturing industry by allowing for greater precision, consistency, and speed in the shaping process. Instead of relying on hand-shaping techniques, which can be time-consuming and inconsistent, CNC machines use precise measurements and cutting tools to create highly accurate and repeatable shapes.

The process of shaping a surfboard using a CNC machine typically involves the following steps:

Designing the shape: The surfboard designer or shaper uses computer-aided design (CAD) software to create a digital model of the surfboard shape.

Preparing the blank: The surfboard blank, which is typically made from foam, is mounted onto the CNC machine and secured in place.

Programming the machine: The shaper uses specialized software to create a toolpath for the machine, which determines the specific movements of the cutting tools to achieve the desired shape.

Cutting the shape: The CNC machine uses a variety of cutting tools, such as routers or hotwires, to cut and shape the foam blank according to the programmed toolpath.

Finishing and sanding: Once the basic shape is complete, the surfboard may be finished and sanded by hand to smooth out any imperfections and add final touches.

In a variety of embodiments, the temperature range may be from 10 degrees Celsius to 250 degrees Celsius. Temperature range is an important consideration in surfboard manufacturing because it affects the properties of the materials used to make the surfboard. Specifically, temperature can affect the chemical reaction that occurs when polyurethane foam is poured into a surfboard blank, as well as the curing process for the fiberglass resin that is used to reinforce the surfboard. For polyurethane foam, the temperature of the foam can affect the density and cell structure of the foam. If the temperature is too low, the foam may not expand enough, resulting in a lower density foam. If the temperature is too high, the foam may expand too much, resulting in a foam with larger cell structures and a lower density. To ensure consistent density and cell structure, the temperature of the foam must be carefully controlled during the manufacturing process.

For fiberglass resin, temperature can affect the curing process. If the temperature is too low, the resin may not cure properly, resulting in a weaker bond between the fiberglass and the foam core of the surfboard. If the temperature is too high, the resin may cure too quickly, resulting in a brittle and weak surfboard. To ensure proper curing, the temperature of the resin and the curing environment must be carefully controlled.

In an embodiment, the polyurethane foam may be a proprietary mixture subject to trade secrets from a hypothetical supplier. Alternatively, the polyurethane foam may be readily available from commercial sources. There are several types of polyurethane foam that are commonly used in the surfboard industry, including:

Low-density foam: This type of foam is lightweight and buoyant, which makes it ideal for use in the core of surfboards.

High-density foam: This type of foam is denser and more durable than low-density foam, which makes it ideal for use in the rails and other high-impact areas of a surfboard.

Blanks: Polyurethane foam blanks are pre-shaped foam cores that are used as the foundation for shaping a surfboard. They come in a variety of sizes and shapes to accommodate different board designs.

Some of the leading suppliers of polyurethane foam for surfboards include:

US Blanks: US Blanks is one of the largest suppliers of polyurethane foam blanks for surfboards. They offer a wide range of foam densities and sizes to accommodate different board designs.

Arctic Foam: Arctic Foam is another major supplier of polyurethane foam blanks for surfboards. They specialize in low-density foam that is specifically designed for use in surfboards.

Foam EZ: Foam EZ is a supplier of polyurethane foam blanks and other materials for surfboard shaping and repair. They offer a variety of foam densities and sizes, as well as tools and supplies for shaping and finishing surfboards.

In an further embodiment, the EPS foam may be purchased from readily available sources based on its use and intentional features and characteristics. There are several types of EPS foam blanks that are available, including:

Low-density EPS: This type of EPS foam is lightweight and buoyant, which makes it ideal for use in the core of surfboards.

High-density EPS: This type of EPS foam is denser and more durable than low-density EPS, which makes it ideal for use in the rails and other high-impact areas of a surfboard.

Molded EPS: This type of EPS foam is molded into a specific shape, which can reduce waste and make it easier to shape the surfboard.

Some of the leading suppliers of EPS foam blanks for surfboards include:

Marko Foam: Marko Foam is a leading supplier of EPS foam blanks for surfboards. They offer a variety of densities and sizes to accommodate different board designs, as well as other materials and supplies for shaping and finishing surfboards.

Greenlight Surf Supply: Greenlight Surf Supply is another major supplier of EPS foam blanks for surfboards. They specialize in eco-friendly materials and offer a range of densities and sizes to accommodate different board designs.

Arctic Foam: In addition to polyurethane foam, Arctic Foam also offers a range of EPS foam blanks for surfboards. They offer a variety of densities and sizes to accommodate different board designs, as well as tools and supplies for shaping and finishing surfboards.

Overall, there are many suppliers of EPS foam blanks for surfboards, and the choice of supplier will depend on factors such as the surfer's location, board design, and budget, as well as considerations for eco-friendliness and other features.

In an embodiment, a stringer may be used in the manufacture of the surfboard. A stringer is a thin, narrow strip of material that runs down the center of a surfboard, from nose to tail. The stringer is typically made of wood, although other materials such as foam or carbon fiber can also be used. It is embedded into the foam core of the surfboard during the shaping process. The stringer serves several important functions in a surfboard. First, it provides added stiffness and strength to the surfboard, which can help prevent the board from flexing too much and losing speed and control. Second, it can help distribute the force of impacts evenly throughout the board, reducing the risk of damage or breakage. Third, it can help maintain the rocker, or curvature, of the surfboard over time, which can impact its performance in the water. The number and size of stringers used in a surfboard can vary depending on the design and intended use of the board. Some surfboards have no stringers at all, while others may have multiple stringers of different sizes and materials. The choice of stringer depends on factors such as the surfer's weight, skill level, and surfing style, as well as the conditions in which the board will be used.

In yet another embodiment, the stringer may be bio-friendly and recycled. In another embodiment, the stringer may be a composite stringer. In recent years, there has been growing interest in developing more environmentally friendly surfboards, including the use of biodegradable or sustainable materials for the stringer. Some examples of bio-friendly surfboard stringer materials include:

Wood: Wood has been used as a surfboard stringer material for decades, and it remains a popular choice due to its strength and natural aesthetic. Sustainable and locally sourced woods such as balsa, paulownia, and bamboo are becoming more common, and some manufacturers are exploring new ways to reduce waste and maximize the use of each piece of wood.

Flax: Flax fiber is a renewable and biodegradable material that has been used in a variety of industries, including automotive and aerospace. In surfboard manufacturing, flax can be used as a replacement for fiberglass or carbon fiber in the stringer or other structural elements. Flax has similar properties to fiberglass and carbon fiber, but it is lighter and more flexible, which can improve the performance of the surfboard.

Cork: Cork is a natural and renewable material that is lightweight, buoyant, and resilient. It can be used as a replacement for foam in the core of the surfboard, or as a stringer material. Cork stringers can provide added stiffness and strength to the surfboard, while also reducing the use of non-renewable materials.

Composite stringers are a type of surfboard stringer that are made by combining two or more different materials to create a single, high-performance component. Composite stringers can be made from a wide range of materials, including fiberglass, carbon fiber, Kevlar, and other high-strength fibers, as well as foam, wood, or other materials.

The advantage of composite stringers is that they can offer the best properties of each material, while minimizing their weaknesses. For example, a composite stringer made from fiberglass and carbon fiber can provide the stiffness and strength of carbon fiber, while also being more affordable and easier to work with than pure carbon fiber. Similarly, a composite stringer made from foam and wood can provide the natural aesthetic and stiffness of wood, while also being lighter and more resistant to rot and decay.

Composite stringers can be made using a variety of manufacturing processes, such as wet layup, pre-preg, or vacuum bagging. The exact process will depend on the materials used and the desired properties of the final product. composite stringers are a popular choice for surfboard manufacturers and surfers who want a high-performance and durable surfboard. They offer a wide range of customization options and can be tailored to meet the specific needs of individual surfers and surfboard designs.

In an embodiment of the invention the surfboard manufactured by the aforementioned process has the desired properties of a surfboard namely increased strength, manoeuvrability and sufficient buoyancy. As for an optimum performance of the surfer, the surfboard should have a balance of strength and flexibility in order to provide speed and manoeuvrability to the surfer. The method of manufacturing of the surfboard as provided by the present invention is able to provide such a surfboard comprising of a polyurethane (PU)-expanded polystyrene (EPS) hybrid material.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A method of manufacturing a polyurethane-expanded polystyrene hybrid material surfboard, the method comprising:
(i) inserting a sheet of expanded polystyrene comprising a plurality of positioning lugs into an interior of a mould cavity formed from at least one mould;
(ii) clamping the mould such that the sheet of expanded polystyrene is enclosed;
(iii)injecting polyurethane into the mould cavity such that the void between the expanded polystyrene and mould cavity is filled with the polyurethane;
(iv) setting and removing the surfboard from the mould;
(v) subjecting the surfboard blank to further processing to fine tune the surfboard profile and shape; and
(vi) glassing the shaped board using bio-based epoxy resin along with advance recycled cloth fibres and finally subjecting to sanding process to obtain the final surfboard.

2. The method of manufacturing a polyurethane-expanded polystyrene hybrid material surfboard as claimed in claim 1, wherein the expanded polystyrene (EPS) sheet is manufactured using a pre-designed mould.

3. The method of manufacturing a polyurethane-expanded polystyrene hybrid material surfboard as claimed in claim 1, wherein the polyurethane blank moulds are of pre-designed shapes to customize the finished product dimensions.

4. The method of manufacturing a polyurethane-expanded polystyrene hybrid material surfboard as claimed in claim 2 wherein, the moulds for manufacturing expanded polystyrene sheet and the mould in which the expanded polystyrene sheet is inserted for injecting polyurethane are made to have a plurality of positioning lugs.

5. The method of manufacturing a polyurethane-expanded polystyrene hybrid material surfboard as claimed in claim 1, wherein the polyurethane mixture for injecting into the mould is prepared by weighing each ingredient of the polyurethane mixture i.e. ISO-POLY in a predetermined ratio and mixed on purpose built mixers to get the exact consistency of the Polyurethane foam.

6. The method of manufacturing a polyurethane-expanded polystyrene hybrid material surfboard as claimed in claim 1,, wherein the step of setting and removing the finished surfboard from the mould comprises the steps of:
covering the blank in the mould comprising polyurethane (PU) and expanded polystyrene (EPS) foam with specialised paper;
closing the mould using locking hydraulic mechanism;
leaving it for 10-120 minutes for the PU foam to react with itself at the pre-set temperature;
taking out the blank made of the hybrid material of EPS and PU and allowed it to cool for 1 hour.

7. The method of manufacturing a polyurethane-expanded polystyrene hybrid material surfboard as claimed in claim 1, wherein the further processing of the surfboard comprises the steps of:
removing the paper from the blank made of the hybrid material of EPS and PU
steaming and curing the blank wherein the process comprises of wetting the surface of the PU foam from top to bottom and placing into a steam room;
removing the blank from the steaming room and allowing it to dry;
gluing the stringers to the blank wherein the stringers may be made of wood, or a variety of composite stringer materials; and
profiling and shaping the surfboard in a Cnc shaping machine and sanding to obtain a shaped surfboard.

8. A surfboard as manufactured by the method as claimed in claim 1, wherein the surfboard is comprising of a polyurethane (PU)-expanded polystyrene (EPS) hybrid material and has a nose 201, a tail 202, a top surface 203, a bottom surface 204, a deck 205 and a stringer 208 wherein the bottom surface of the surfboard comprises the lugs 205 for installing the fins are present at the tail area 202.

9. The surfboard as claimed in claim 8, wherein the surfboard has increased strength, manoeuvrability and sufficient buoyancy.
